(19) United States
(12) Patent Application Publication
(10) Pub. No.: US 2019/0267729 A1
(43) Pub. Date: Aug. 29, 2019

(54) INSULATING COVER AND TERMINAL BLOCK WITH INSULATING COVER

(71) Applicant: SUMITOMO WIRING SYSTEMS, LTD., Mie (JP)

(72) Inventor: Kanji HORIUCHI, Mie (JP)

(73) Assignee: SUMITOMO WIRING SYSTEMS, LTD., Mie (JP)

(21) Appl. No.: 16/308,309

(22) PCT Filed: May 23, 2017
(86) PCT No.: PCT/JP2017/019186

§ 371 Date: Dec. 7, 2018

(30) Foreign Application Priority Data
Jun. 10, 2016 (JP) 2016-115807

(51) Int. Cl. H01R 9/24; H02K 5/22; H01R 4/70

(52) U.S. Cl. CPC H01R 9/24; H01R 4/70; H02K 5/225

(57) ABSTRACT

An insulating cover that is attached to a terminal block having at least two bus bars and a terminal block-side insulating wall that is provided between the two bus bars. The insulating cover includes a cover-side insulating wall in which a first wall surface faces a first wall surface of the terminal block-side insulating wall; and a connecting wall that strikes the terminal block-side insulating wall and restricts attachment when attempting to attach the insulating cover such that a second wall surface of the cover-side insulating wall faces a second wall surface of the terminal block-side insulating wall.

### FIELD OF THE INVENTION

The technology disclosed in the instant specification relates to an insulating cover that is attached to a terminal block, and a terminal block with insulating cover.

### BACKGROUND OF THE INVENTION

Conventionally, an insulating cover is known that is attached to a terminal block having at least two conductors (for example, see Patent Literature 1). Specifically, a breaker described in the background art of Patent Literature 1 includes a plurality of power supply-side connection terminal blocks (equivalent to a conductor), and a crimped terminal of an electric wire is respectively fastened to the plurality of power supply-side connection terminal blocks by a fastener. Then, the plurality of fasteners are covered by a single breaker terminal cover (equivalent to an insulating cover) so as to be completely contained.

### RELATED ART

### Patent Literature

Patent Literature 1: Japanese Patent Laid-open Publication No. 2010-80074

### SUMMARY OF THE INVENTION

### Problems to be Solved by the Invention

In this regard, with a terminal block having at least two conductors, an insulating wall (herein referred to as a “terminal block-side insulating wall”) may in some cases be provided between the two conductors in order to ensure a creepage distance between the two adjacent conductors. In addition, in some cases an insulating wall (herein referred to as a “cover-side insulating wall”) for insulating the two conductors may also be provided to the insulating cover in order to increase insulation performance, and the insulating cover may be attached such that a first wall surface of the cover-side insulating wall faces a first wall surface of the terminal block-side insulating wall.

However, in such cases, there have been instances where, when a worker attaches the insulating cover, the cover-side insulating wall may enter on the opposite side (i.e., on a second wall surface side of the terminal block-side insulating wall) of the terminal block-side insulating wall from the side to which attachment is intended (i.e., on the first wall surface side of the terminal block-side insulating wall, described above), and attaching the insulating cover is difficult.

In the instant specification, a technology is disclosed that improves ease of attachment when attaching an insulating cover provided with a cover-side insulating wall to a terminal block having a terminal block-side insulating wall.

### Means for Solving the Problems

An insulating cover disclosed by the instant specification is an insulating cover that is attached to a terminal block having at least two conductors and a terminal block-side insulating wall that is provided between the two conductors. The insulating cover includes a cover-side insulating wall in which a first wall surface faces a first wall surface of the terminal block-side insulating wall; and a restricting portion that strikes the terminal block-side insulating wall and restricts attachment when attempting to attach the insulating cover such that a second wall surface of the cover-side insulating wall faces a second wall surface of the terminal block-side insulating wall.

With the insulating cover described above, it is possible to restrict the cover-side insulating wall from mistakenly entering on the opposite side of the terminal block-side insulating wall from the side to which attachment is intended. Therefore, ease of attachment is improved when attaching the insulating cover provided with the cover-side insulating wall to the terminal block having the terminal block-side insulating wall.

Also, positions of front ends in an attachment direction of the insulating cover for both the cover-side insulating wall and the restricting portion may substantially coincide in the attachment direction.

For example, taking a case where the position of the attachment direction front end of the restricting portion is further rearward in the attachment direction than the position of the attachment direction front end of the cover-side insulating wall, the restricting portion strikes the terminal block-side insulating wall after a portion of the cover-side insulating wall enters on the opposite side. Therefore, although the work of reattachment is less cumbersome compared to a case lacking the restricting portion, nevertheless reattachment work may arise. In contrast, when the position of the attachment direction front end of the cover-side insulating wall and the position of the attachment direction front end of the restricting portion substantially coincide, the restricting portion strikes the terminal block-side insulating wall before a portion of the cover-side insulating wall enters on the opposite side, and therefore the ease of attaching the insulating cover is further improved.

In addition, the terminal block may include three of the conductors and two of the terminal block-side insulating walls that are individually provided between the two adjacent conductors. The insulating cover may include two of the cover-side insulating walls, which are two cover-side insulating walls that enter between the two terminal block-side insulating walls and in which a first of the cover-side insulating walls faces a first of the terminal block-side insulating walls, and a second of the cover-side insulating walls faces a second of the terminal block-side insulating walls. The restricting portion may be a connecting wall that connects the first cover-side insulating wall and the second cover-side insulating wall.

The restricting portion can also be provided in a cantilever form to the second wall surface of each cover-side insulating wall described above, for example, but in such a case, the strength of the restricting portion may be reduced due to the cantilevering, and the restricting portion may fracture when striking the terminal block-side insulating wall. With the insulating cover described above, both sides of the restricting portion are connected to the two cover-side insulating walls, and therefore the strength of the restricting portion can be improved as compared to the case where the restricting portion is provided in a cantilever form.

In addition, the terminal block may include a surface facing a wall surface of the connecting wall, and when the insulating cover is attached to the terminal block, the insulating cover may be attached while the wall surface of the connecting wall moves in a direction parallel to the facing surface, and a tapered surface that inclines so as to move away from the facing surface as the tapered surface moves forward in the attachment direction of the insulating cover may be formed on the wall surface of the connecting wall.

In a case where the terminal block includes the surface facing the wall surface of the connecting wall and where, when the insulating cover is attached to the terminal block, the insulating cover is attached while the wall surface of the connecting wall moves in the direction parallel to the facing surface, there is a possibility that an end face of the connecting wall that faces forward in the attachment direction may strike a surface continuous with the facing surface of the terminal block, and that the ease of attachment may decrease. With the insulating cover described above, the tapered surface is formed on the connecting wall, and therefore a decrease in the ease of attaching the insulating cover can be inhibited.

In addition, a terminal block with insulating cover disclosed in the instant specification includes a terminal block having at least two conductors and a terminal block-side insulating wall that is provided between the two conductors; and the insulating cover described in any one of claims 1 through 4.

With the terminal block with insulating cover described above, ease of attachment is improved when attaching the insulating cover provided with the cover-side insulating wall to the terminal block having the terminal block-side insulating wall.

### Effect of the Invention

According to the technology disclosed in the instant specification, ease of attachment can be improved when attaching an insulating cover provided with a cover-side insulating wall to a terminal block having a terminal block-side insulating wall.

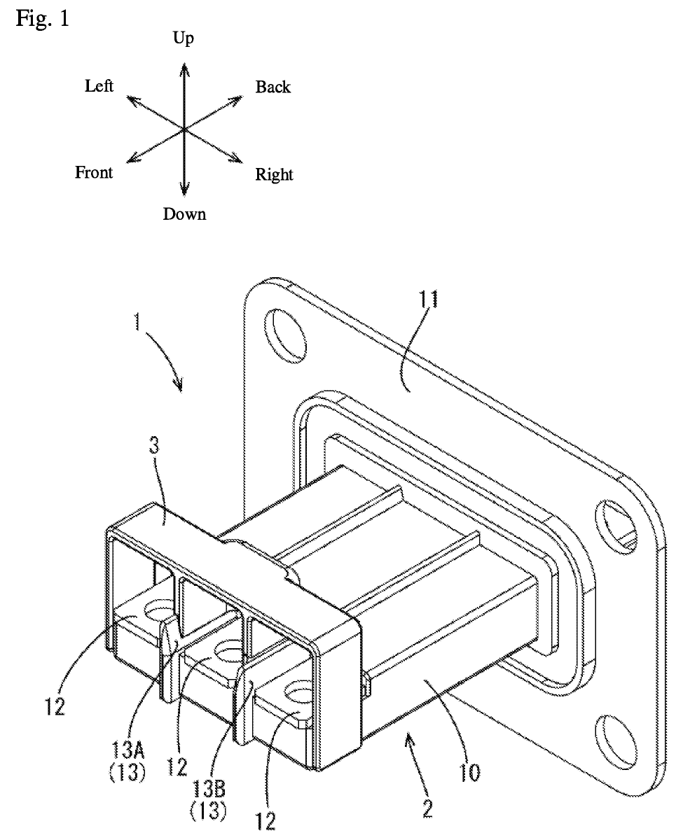

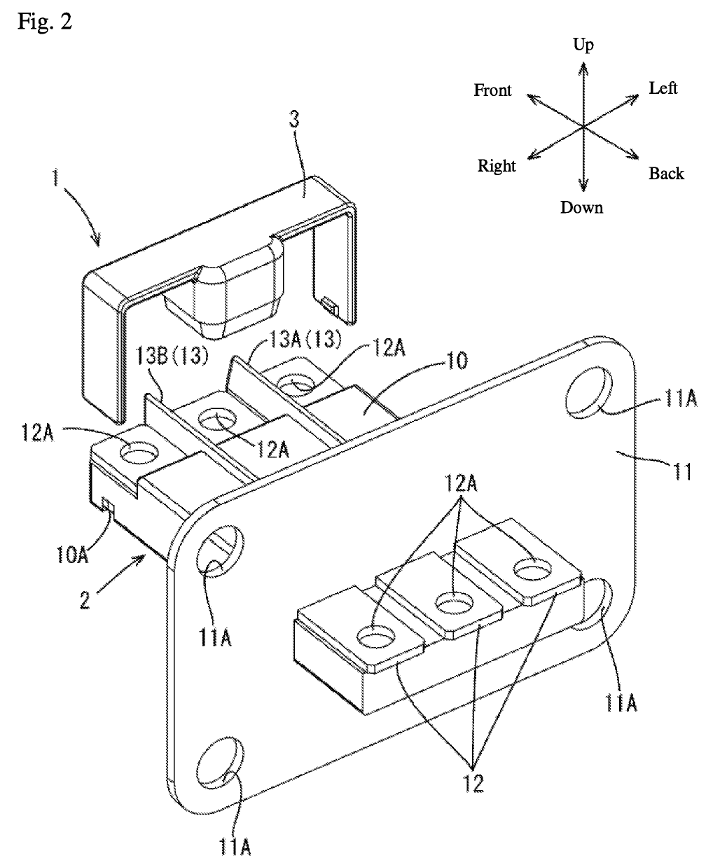

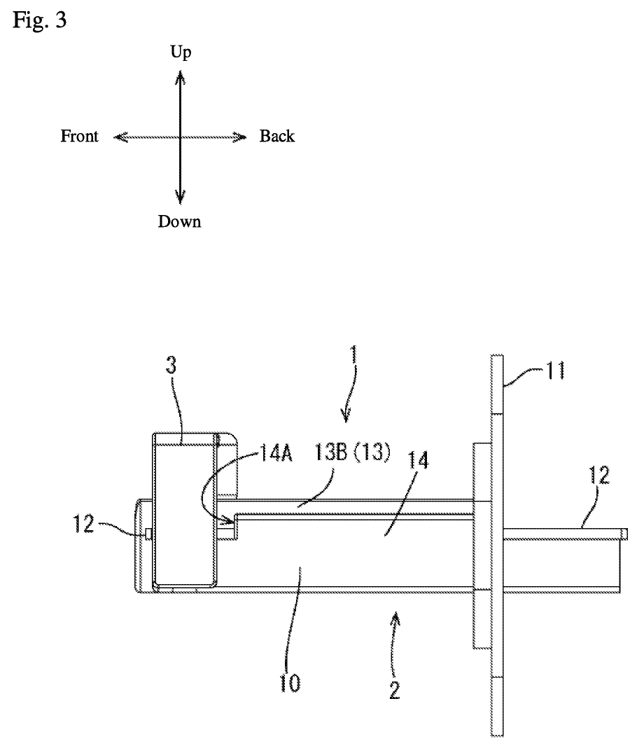

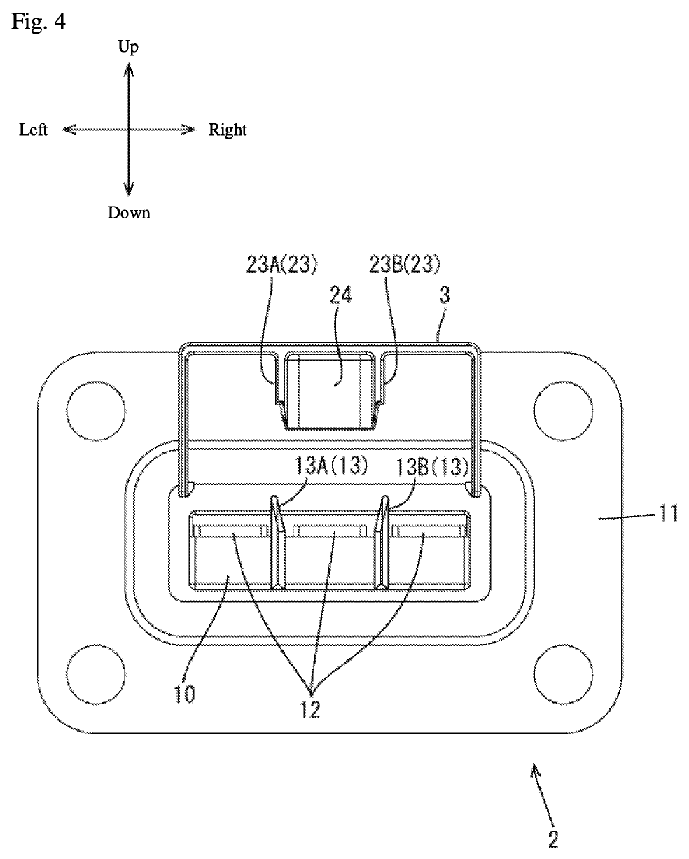

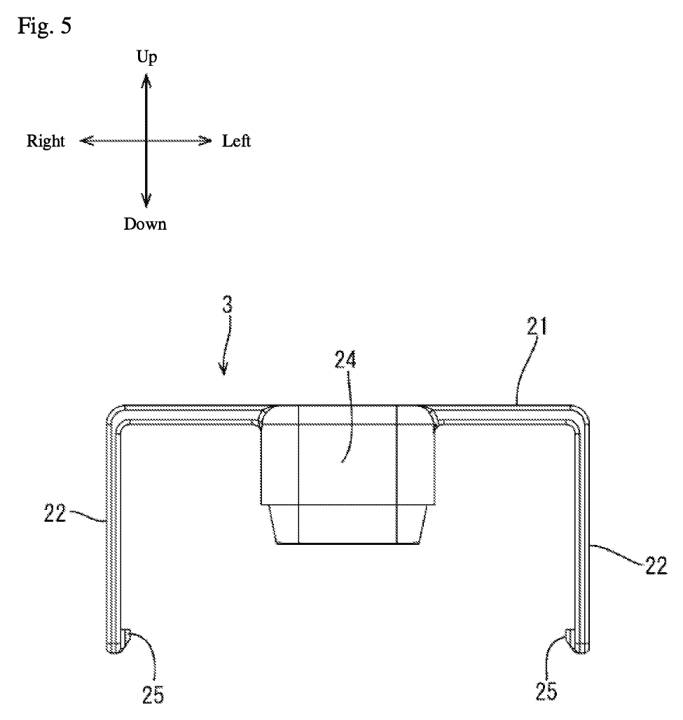

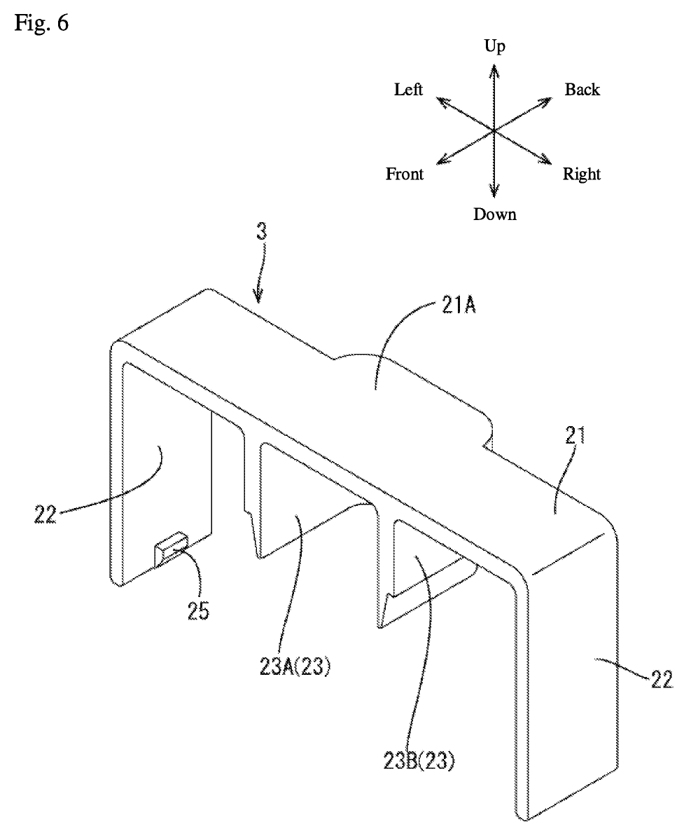

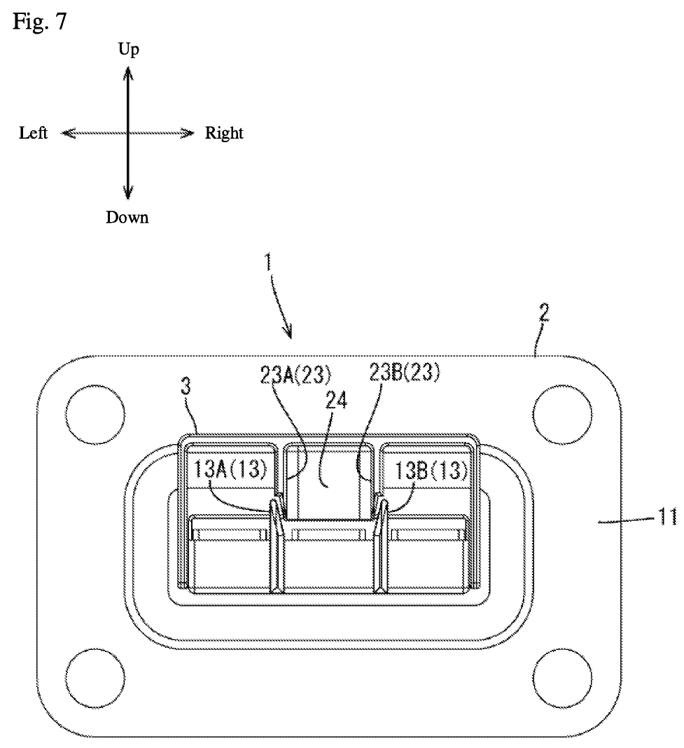

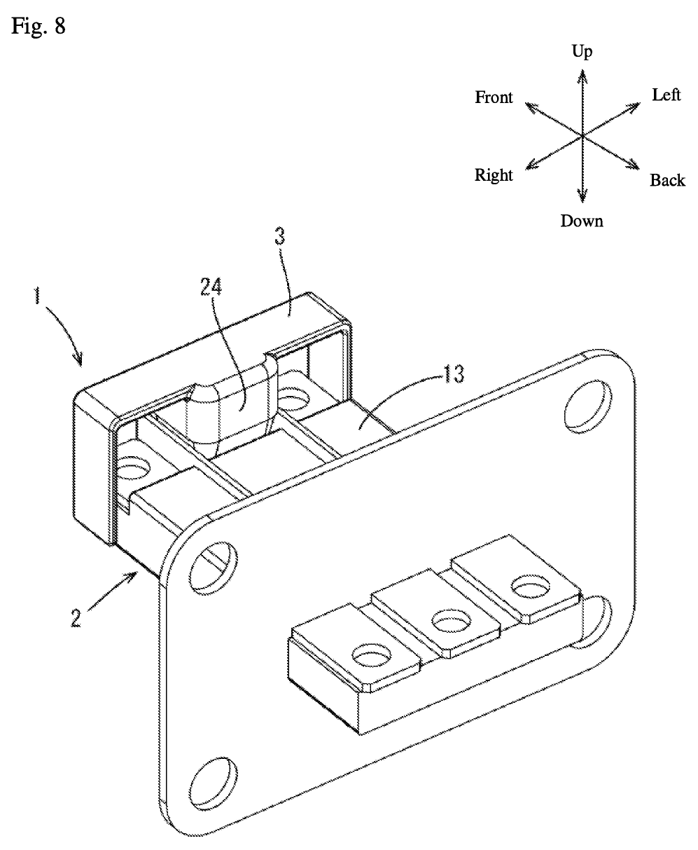

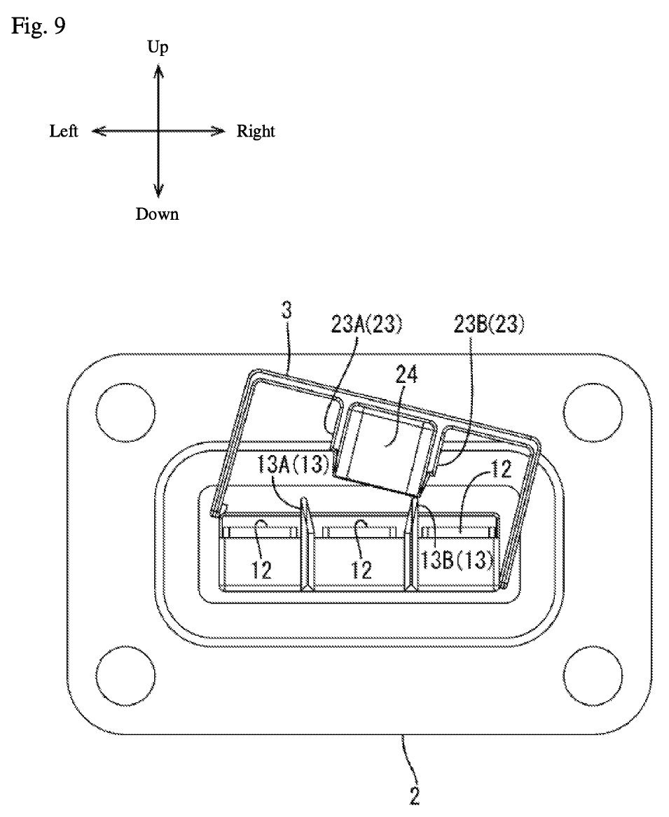

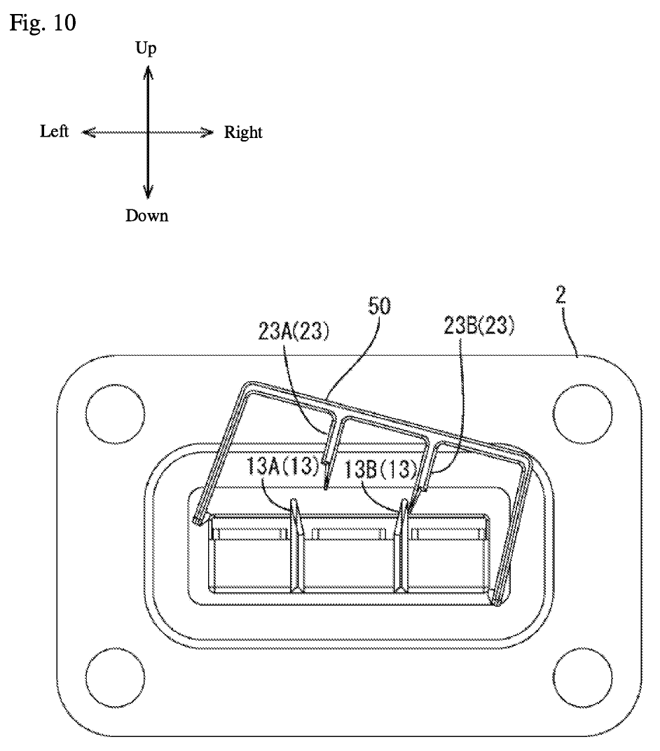

### BRIEF DESCRIPTION OF THE DRAWINGS

[FIG. 1] is a perspective view, from a front side, of a terminal block according to an embodiment, and of an insulating cover that is attached to the terminal block.

[FIG. 2] is a perspective view, from a rear side, of the terminal block and the insulating cover prior to attachment.

[FIG. 3] is a side view of the terminal block and the attached insulating cover.

[FIG. 4] is a front view, from the front side, of the terminal block and the insulating cover prior to attachment.

[FIG. 5] is a front view, from the rear side, of the insulating cover.

[FIG. 6] is a perspective view, from the front side, of the insulating cover.

[FIG. 7] is a front view, from the front side, of the terminal block and the insulating cover prior to complete attachment.

[FIG. 8] is a perspective view, from the rear side, of the terminal block and the attached insulating cover.

[FIG. 9] is a front view, from the front side, of the terminal block, and of an insulating cover for which an attempt was made to attach the insulating cover such that a cover-side insulating wall is opposite a second wall surface of a terminal block-side insulating wall.

[FIG. 10] is a front view, from the front side, of the terminal block and an insulating cover according to a comparative example.

### MODE FOR CARRYING OUT THE INVENTION

### Embodiment

The embodiment is described based on FIGS. 1 through 10. In the description that follows, the up-down direction, front-back direction, and left-right direction are based on the up-down direction, front-back direction, and left-right direction illustrated in FIG. 1.

First, an overview of a terminal block with insulating cover 1 according to the present embodiment is described with reference to FIG. 1. The terminal block with insulating cover 1 is attached to a casing of an inverter installed in a hybrid automobile, an electric automobile, or the like, and is electrically connected to the inverter and a three-phase motor, the terminal block with insulating cover 1 including a terminal block 2 and an insulating cover 3 that is attached to the terminal block 2.

(1) Terminal Block

As illustrated in FIGS. 1 and 2, the terminal block 2 includes a base 10, a flanged portion 11, three bus bars 12 (an example of a conductor), and two terminal block-side insulating walls 13 (13A and 13B). The base 10 is made of a synthetic resin, and has a rectangular shape from a top view. In addition, the base 10 has a certain degree of thickness in the up-down direction, and has a nut (not shown in the drawings), described below, that is embedded by molding in both front-back direction end portions. Also, as illustrated in FIG. 3, a step portion 14, where middle portions of the bus bars 12 are embedded, is formed forward of the flanged portion 11 on a top surface of the base 10.

As illustrated in FIG. 2, the flanged portion 11 is formed in a substantially rectangular plate shape, and is integrally molded with the base 10 such that the base 10 passes through the flanged portion 11 in a plate thickness direction. The flanged portion 11 is for fixating the terminal block 2 to the casing of the inverter using bolts, and is provided with bolt insertion holes 11A at four corners.

The bus bars 12 are elongated plate-shaped metal plates formed with copper, a copper alloy, or the like, and a middle portion between both front-back direction end portions is embedded in the step portion 14 by molding in a state of resting on the top surface of the base 10. In addition, respective bolt insertion holes 12A are provided to both front-back direction end portions of the bus bars 12. Meanwhile, the nuts described above are embedded in the base 10 below each of the bolt insertion holes 12A. A terminal fitting connected to a foremost end portion of an electric wire extending from the three-phase motor (or a bus bar) is stacked on a forward end portion of the bus bar 12, and the terminal fitting and bus bar are co-fitted to the nut with a bolt. In addition, a terminal fitting connected to a foremost end portion of an electric wire extending from the inverter (or a bus bar) is stacked on a rearward end portion of the bus bar 12, and the terminal fitting and bus bar 12 are co-fitted to the nut with a bolt.

Each of the two terminal block-side insulating walls 13 is for ensuring a creepage distance between two adjacent bus bars 12, and stands upright above and from between the two adjacent bus bars 12, forward of the flanged portion 11. As illustrated in FIG. 4, a tapered surface that inclines leftward as the tapered surface rises is formed on a top end portion of a rightward-facing surface of the left terminal block-side insulating wall 13A. Similarly, a tapered surface that inclines rightward as the tapered surface rises is formed on a top end portion of a leftward-facing surface of the right terminal block-side insulating wall 13B.

(2) Insulating Cover

As illustrated in FIG. 1, the insulating cover 3 is attached to a front portion of the terminal block 2. The insulating cover 3 includes a canopy portion 21 and a pair of cover attachment portions 22 shown in FIG. 5, two cover-side insulating walls 23 (23A and 23B) shown in FIG. 6, and a connecting wall 24 shown in FIG. 5. The connecting wall is an example of a restricting portion.

As illustrated in FIG. 6, the canopy portion 21 is formed in an elongated plate shape, and includes a flared portion 21A that flares rearward from substantially a left-right direction middle portion. The pair of cover attachment portions 22 are also each formed in a plate shape, and extend downward from both the left and right sides of the canopy portion 21 in a posture where the surfaces of the plates face each other. An engagement projection 25 that engages with an engagement recess 10A (see FIG. 2) formed on a side surface of the base 10 is provided to a surface of each cover attachment portion 22 that faces the other cover attachment portion 22.

As illustrated in FIGS. 5 and 6, the two cover-side insulating walls 23 and the connecting wall 24 are integrally molded with a bottom surface of the canopy portion 21, and are formed so as to have a squared “U” shape in a cross-section orthogonal to the up-down direction. As illustrated in FIG. 4, a bottom end portion of the left cover-side insulating wall 23A is notched on the left side so as to provide a thinner wall, and a tapered surface that inclines rightward as the tapered surface descends is formed on a leftward-facing surface of the bottom end portion of the left cover-side insulating wall 23A. Similarly, a bottom end portion of the right cover-side insulating wall 23B is notched on the right side so as to provide a thinner wall, and a tapered surface that inclines leftward as the tapered surface descends is formed on a rightward-facing surface of the bottom end portion of the right cover-side insulating wall 23B.

As illustrated in FIG. 5, the connecting wall 24 is connected across its entire height with a rear edge portion of the left cover-side insulating wall 23A and a rear edge portion of the right cover-side insulating wall 23B. A bottom end portion of the connecting wall 24 is notched on the rear side (a near side of the plane of the drawing sheet in FIG. 5) so as to provide a thinner wall, and a tapered surface that inclines forward (a far side of the plane of the drawing sheet in FIG. 5) as the tapered surface descends (an example of forward in an attachment direction of the insulating cover 3) is formed on a rearward-facing surface of the bottom end portion of the connecting wall 24.

In addition, downward-facing end faces of the two cover-side insulating walls 23 and a downward-facing end face of the connecting wall 24 are formed to be coplanar. In other words, a position of the downward-facing end faces of the two cover-side insulating walls 23 (an example of a position of a front end of the cover-side insulating wall in the attachment direction) and a position of the downward-facing end face of the connecting wall 24 (an example of a position of a front end of the restricting portion in the attachment direction) substantially coincide in the up-down direction (i.e., the attachment direction of the insulating cover 3).

(3) Attaching the Insulating Cover

After a terminal fitting is stacked on a forward end portion of each of the bus bars 12 and co-fitted to the nuts, the insulating cover 3 is attached to the terminal block 2 from above. FIG. 4 illustrates a case where the insulating cover 3, which is above the terminal block 2, is not offset from the terminal block 2 in the left-right direction when attaching the insulating cover 3 to the terminal block 2. In such a case, when a worker moves the insulating cover 3 downward, the connecting wall 24 does not strike the left and right terminal block-side insulating walls 13, and therefore the bottom end portions of the two cover-side insulating walls 23 enter between the two terminal block-side insulating walls 13 as illustrated in FIG. 7.

Then, the bottom end portion (tapered surface) of the leftward-facing wall surface (an example of a first wall surface of the cover-side insulating wall) of the left cover-side insulating wall 23A faces the top end portion (tapered surface) of the rightward-facing wall surface (an example of a first wall surface of the terminal block-side insulating wall) of the left terminal block-side insulating wall 13A, and the bottom end portion (tapered surface) of the rightward-facing wall surface (an example of the first wall surface of the cover-side insulating wall) of the right cover-side insulating wall 23B faces the top end portion (tapered surface) of the leftward-facing wall surface (an example of the first wall surface of the terminal block-side insulating wall) of the right terminal block-side insulating wall 13B.

Then, when the insulating cover 3 is pressed downward from the state illustrated in FIG. 7, the engagement projections 25 engage with the engagement recesses 10A and the insulating cover 3 is attached to the base 10.

As illustrated in FIG. 8, when the insulating cover 3 is attached to the terminal block 2, the bottom end portion (tapered surface) of the rearward-facing wall surface of the connecting wall 24 faces a forward-facing step face 14A (see FIG. 3) of the step portion 14 of the terminal block 2. In other words, the terminal block 2 includes a surface (step face 14A) that faces the wall surface of the connecting wall 24, and when the insulating cover 3 is attached to the terminal block 2, the insulating cover 3 is attached while the rearward-facing wall surface moves in a direction parallel to the step face 14A.

(4) Effects of the Embodiment

Effects of the insulating cover 3 according to the present embodiment are described by way of comparison to a comparative example illustrated in FIG. 10. An insulating cover 50 (comparative example) illustrated in FIG. 10 has the connecting wall 24 eliminated from the insulating cover 3 according to the present embodiment. Without the connecting wall 24, when attempting to attach the insulating cover 50 to the terminal block 2 in a state offset to the right, as illustrated in FIG. 10, there have been instances where the right cover-side insulating wall 23B mistakenly enters on an opposite side (i.e., to the right of the right terminal block-side insulating wall 13B) of the right terminal block-side insulating wall 13B from the side to which attachment is intended (i.e., the left side of the right terminal block-side insulating wall 13B), and attaching the insulating cover 50 is difficult.

In other words, there have been instances of mistakenly attempting to attach the insulating cover 50 such that the leftward-facing wall surface of the right cover-side insulating wall 23B (an example of a second wall surface of the cover-side insulating wall) faces the rightward-facing wall surface of the right terminal block-side insulating wall 13B (an example of a second wall surface of the terminal block-side insulating wall), and where attaching the insulating cover 50 is difficult. Cases of attempting to attach the insulating cover 50 to the terminal block 2 when offset to the left are similar.

In contrast, with the insulating cover 3, as illustrated in FIG. 9, when attempting to attach the insulating cover 3 such that the leftward-facing wall surface of the right cover-side insulating wall 23B faces the rightward-facing wall surface of the right terminal block-side insulating wall 13B, the connecting wall 24 strikes the right terminal block-side insulating wall 13B and attachment is restricted. In other words, with the insulating cover 3, it is possible to restrict the cover-side insulating wall 23 from mistakenly entering on the opposite side of the terminal block-side insulating wall 13 from the side to which attachment is intended. Therefore, ease of attachment is improved when attaching the insulating cover 3, which is provided with the cover-side insulating walls 23, to the terminal block 2, which includes the terminal block-side insulating walls 13.

Moreover, with the insulating cover 3, the position of the downward-facing end faces of the two cover-side insulating walls 23 and the position of the downward-facing end face of the connecting wall 24 substantially coincide in the up-down direction. For example, when the position of the downward-facing end face of the connecting wall 24 is further upward than the position of the downward-facing end faces of the cover-side insulating walls 23, the connecting wall 24 strikes the terminal block-side insulating walls 13 after a portion of the cover-side insulating walls 23 enters on the opposite side from the side to which attachment is intended. Therefore, although the work of reattachment is less cumbersome compared to a case lacking the connecting wall 24, nevertheless reattachment work may arise. In contrast, when the position of the downward-facing end faces of the cover-side insulating walls 23 and the position of the downward-facing end face of the connecting wall 24 substantially coincide in the up-down direction, the connecting wall 24 strikes the terminal block-side insulating walls 13 before a portion of the cover-side insulating walls 23 enters on the opposite side, and therefore the ease of attaching the insulating cover 3 is further improved.

Moreover, with the insulating cover 3, the restricting portion is the connecting wall 24, which connects the left cover-side insulating wall 23A and the right cover-side insulating wall 23B. The restricting portion can also be provided in a cantilever form to the second wall surface of each cover-side insulating wall 23 described above, for example, but in such a case, the strength of the restricting portion may be reduced due to the cantilevering, and the restricting portion may fracture when striking the terminal block-side insulating walls 13. With the insulating cover 3, both sides of the restricting portion are connected to the two cover-side insulating walls 23, and therefore the strength of the restricting portion can be improved as compared to the case where the restricting portion is provided in a cantilever form.

Furthermore, with the insulating cover 3, the terminal block 2 includes the step face 14A that faces the rearward-facing wall surface of the connecting wall 24, and when the insulating cover 3 is attached to the terminal block 2, the insulating cover 3 is attached while the rearward-facing wall surface of the connecting wall 24 moves in the direction parallel to the step face 14A. In such a case, there is a possibility that the downward-facing end face of the connecting wall 24 (i.e., the end face on the connecting wall 24 that faces forward in the attachment direction) may strike a top surface of the step portion 14 of the terminal block 2 (i.e., a surface continuous with the step face 14A), and that the ease of attachment may decrease. With the insulating cover 3, the tapered surface is formed on the bottom end portion of the rearward-facing wall surface of the connecting wall 24, and therefore when attaching the insulating cover 3, the connecting wall 24 is guided to the front side of the step face 14A by the tapered surface. Therefore, a decrease in the ease of attaching the insulating cover 3 can be inhibited.

(Other Embodiments)

The technology disclosed by the instant specification is not limited to the embodiment described by way of the above recitation and the drawings; instead, the technical scope disclosed by the instant specification also includes, for example, the following embodiments.

(1) In the embodiment described above, a case is described as exemplary in which the insulating cover 3 is attached to the terminal block 2 from above; however, the insulating cover 3 may also be attached to the terminal block 2 from the front toward the rear. Even in such a case, in the embodiment described above, the connecting wall 24 is provided so as to connect the rear edge portions of the two cover-side insulating walls 23, and therefore it is possible to restrict the cover-side insulating walls 23 from mistakenly entering on the opposite side from the side to which attachment is intended.

(2) In the embodiment described above, the connecting wall 24 which connects the two cover-side insulating walls 23 is described as exemplary of the restricting portion; however, the restricting portion is not necessarily the connecting wall 24. The restricting portion may also be, for example, a projection that extends in a cantilever form from the second wall surface of each of the cover-side insulating walls 23 described above toward the other cover-side insulating wall 23.

(3) In the embodiment described above, a case is described as exemplary in which three bus bars 12 and two terminal block-side insulating walls 13 are provided to the terminal block 2, and two cover-side insulating walls 23 are provided to the insulating cover 3. In contrast, the number of bus bars 12 may be two and one terminal block-side insulating wall 13 may be provided to the terminal block 2, and also one cover-side insulating wall 23 may be provided to the insulating cover 3. Alternatively, the number of bus bars 12 may be four or more and three or more terminal block-side insulating walls 13 may be provided to the terminal block 2, and also three or more cover-side insulating walls 23 may be provided to the insulating cover 3.

(4) In the embodiment described above, a case is described as exemplary in which the tapered surface is formed on the connecting wall 24; however, a tapered surface is not necessarily provided.

### DESCRIPTION OF REFERENCE NUMERALS

1 . . . Terminal block with insulating cover, 2 . . . Terminal block, 3 . . . Insulating cover, 12 . . . Bus bar (an example of a conductor), 13 (13A and 13B) . . . Terminal block-side insulating wall, 14A . . . Step face (an example of a surface facing a wall surface of a connecting wall), 23 (23A and 23B) . . . Cover-side insulating wall, 24 . . . Connecting wall (an example of a restricting portion)

1. An insulating cover configured to be attached to a terminal block having at least two conductors and a terminal block-side insulating wall that is provided between the two conductors, the insulating cover comprising:
a cover-side insulating wall having a first wall surface which faces a first wall surface of the terminal block-side insulating wall; and
a restricting portion that strikes the terminal block-side insulating wall and restricts attachment when attempting to attach the insulating cover such that a second wall surface of the cover-side insulating wall faces a second wall surface of the terminal block-side insulating wall.

2. The insulating cover according to claim 1, wherein positions of front ends in an attachment direction of the insulating cover of both the cover-side insulating wall and the restricting portion substantially coincide in the attachment direction.

3. The insulating cover according to claim 1, wherein the terminal block includes three of the conductors and two of the terminal block-side insulating walls that are individually provided between two adjacent conductors,
the insulating cover includes two of the cover-side insulating walls which enter between the two terminal block-side insulating walls, and in which a first of the cover-side insulating walls faces a first of the terminal block-side insulating walls, and a second of the cover-side insulating walls faces a second of the terminal block-side insulating walls, and
the restricting portion is a connecting wall that connects the first cover-side insulating wall and the second cover-side insulating wall.

4. The insulating cover according to claim 3, wherein the terminal block includes a facing surface facing a wall surface of the connecting wall,
when the insulating cover is attached to the terminal block, the insulating cover is attached while the wall surface of the connecting wall moves in a direction parallel to the facing surface, and
the wall surface of the connecting wall includes a tapered surface that inclines so as to move away from the facing surface as the tapered surface moves forward in an attachment direction of the insulating cover.

5. A terminal block with insulating cover comprising:
a terminal block having at least two conductors and a terminal block-side insulating wall that is provided between the two conductors; and
the insulating cover described in claim 1.
